(19) United States
(12) Patent Application Publication
(10) Pub. No.: US 2001/0004372 A1
(43) Pub. Date: Jun. 21, 2001

(54) Arrangement and method for measuring the temperature of a fluid

(76) Inventor: Dieter Engel, Reinfeldt (DE)

Correspondence Address: Walter Ottesen, Patent Attorney, P.O. Box 4026, Gaithersburg, MD, 20885-4026, US

(21) Appl. No.: 09/733,044

(22) Filed: Dec. 11, 2000

(30) Foreign Application Priority Data
Dec. 15, 1999 (DE) 199 60 429.0

(51) Int. Cl. G01K 7/18; G01K 1/14

(52) U.S. Cl. 374/148; 374/183

(57) ABSTRACT

An arrangement for measuring the temperature of fluids has a measuring sensor (4) to which a measuring current is supplied by a current source (11). This arrangement is improved in that the temperature measurement is carried out without significant inherent warming of the measuring sensor (4). The invention is also directed to a method for carrying out the temperature measurement wherein measuring current pulses are applied to the measuring sensor (4) and the voltage maximum and current maximum, which are generated by the measuring current pulses, drop across the measuring sensor (4) and are detected. A quotient of the voltage maximum and the current maximum is formed and this quotient is an index for the temperature of the fluid.

### FIELD OF THE INVENTION

The invention relates to an arrangement and a method for measuring the temperature of a fluid with a measuring sensor to which a measuring current is applied by a current source.

### BACKGROUND OF THE INVENTION

An arrangement for the combined measurement of the flow velocity and the temperature of a gas is known, for example, from U.S. Pat. No. 3,645,133. To measure the flow velocity, a hot wire in a gas channel is heated to an operating temperature and this hot wire is connected to a measuring bridge. A measurement value proportional to the flow velocity results from a bridge unbalance. To compensate for the influence of temperature of the flow velocity measurement, a measuring sensor is present through which the flow likewise flows and influences the current supply unit of the measuring bridge. A constant overtemperature adjusts at the hot wire compared to the gas temperature because of the compensation of the temperature influence. The known arrangement is preferred for use in ventilating systems in order to measure the gas volume which is inhaled or exhaled by the patient or even to measure the minute volume.

In a temperature measurement, the current, which flows through the measuring sensor, leads however to an inherent warming so that it is not the actual gas temperature which is determined but a measurement value which, in a complex manner, includes the inherent warming of the measurement sensor and the instantaneous flow velocity of the gas in addition to the gas temperature. If one proceeds from a usually flowing measurement current of approximately 10 to 15 milliamperes, then a reduction of the current would considerably reduce the inherent warming but then, simultaneously, the measuring voltage would also drop greatly and the measuring voltage would change only in the order of magnitude of approximately 20 microvolts per degree Kelvin. The further processing of such small measurement voltages requires a very high complexity of circuitry especially when longer feed lines and contact connections between the measuring sensors and the evaluation unit are necessary.

### SUMMARY OF THE INVENTION

It is an object of the invention to provide an arrangement and a measuring method to carry out a temperature measurement within a fluid channel without significant inherent warming of the measuring sensor.

The arrangement of the invention is for measuring the temperature of a fluid and includes: a measuring sensor disposed in the fluid and having an ohmic resistance; a current source for generating and supplying measuring current pulses to the measuring sensor; a voltage detector connected to the measuring sensor for detecting a measurement voltage (U_{M}) across the measuring sensor; a current detector for detecting the measurement current (I_{M}) corresponding to the measurement voltage (U_{M}); a switching circuit for forming a quotient from the measurement voltage (U_{M}) and the measurement current (I_{M}) with the quotient (U_{M}/I_{M}) indicating the ohmic resistance of the measuring sensor.

The method of the invention is for measuring the temperature of a fluid and includes the steps of: providing a measuring sensor disposed in the fluid and the measuring sensor having an ohmic resistance; applying measuring current pulses to the measuring sensor thereby causing a measurement voltage (U_{M}) to drop across the measuring sensor; detecting the measurement voltage (U_{M}) and the measurement current (I_{M}) corresponding thereto; and, forming a quotient (U_{M}/I_{M}) from the measurement voltage (U_{M}) and the measurement current (I_{M}) which indicates the ohmic resistance of the measuring sensor.

The advantage of the invention is essentially that the power, which is supplied to the measuring sensor, can be greatly reduced by selecting a short switch-on time of the measuring current without having to reduce the amplitude of the measuring current. A switch-on time of, for example, 50 microseconds within a period duration of 5 milliseconds effects a reduction of the supplied power by a value of approximately 1:100. In this way, the evaluation can be carried out with measuring currents and measuring voltages which can be processed with a switching complexity which is not excessive without this leading to a significant inherent warming of the measuring sensor.

The measuring method according to the invention comprises applying measuring current pulses to the measuring sensor; detecting the measuring voltage U_{M} which drops across the measuring sensor and is generated by the measuring current pulses, and detecting the corresponding measuring current I_{M}; and, forming the quotient of the measuring voltage U_{M} and the measuring current I_{M}. The quotient provides the ohmic resistance of the measuring sensor and is an index for the temperature of the fluid. It has been shown advantageous to take off the measuring voltage and measuring current synchronously at the end of the measuring current pulse when the transient action is completed. Alternatively, as a voltage, the voltage maximum U_{M} can be determined with a peak voltage detector and, as a measuring current, the measuring current maximum I_{M} can be detected with a peak current detector.

### BRIEF DESCRIPTION OF THE DRAWINGS

The invention will now be described with reference to the drawings wherein:

FIG. 1 is a schematic of a measuring arrangement according to the invention;

FIG. 2a shows the time-dependent trace of the control pulse Uₛ(t) of the pulse voltage source of the measuring arrangement of FIG. 1;

FIG. 2b is a time-dependent trace of the current I(t) at the measuring sensor;

FIG. 2c shows the time-dependent trace of the voltage U(t) also at the measuring sensor; and,

FIG. 3 is a graph showing the inherent warming of the measuring sensor in dependence upon the square of the measuring current and the ratio of the switch-on time to the period duration.

### DESCRIPTION OF THE PREFERRED EMBODIMENTS OF THE INVENTION

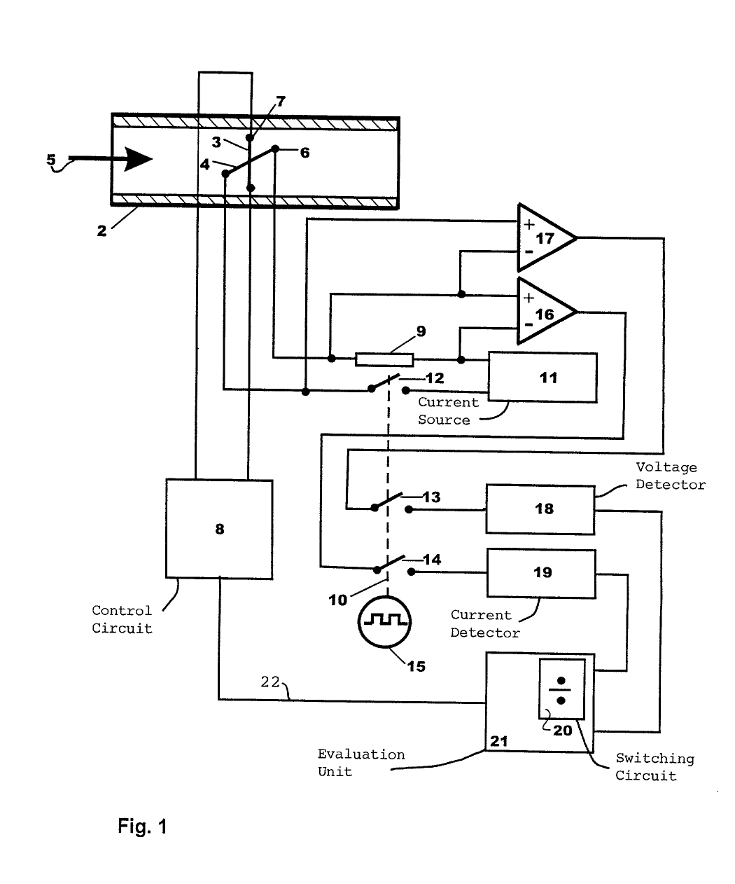

FIG. 1 shows schematically a measuring arrangement 1 with which the flow velocity is measured in combination with the gas temperature. A hot wire 3 for measuring the flow velocity is mounted in a channel 2 through which the gas flows and a measuring sensor 4 for measuring temperature is also mounted in the channel 2. The hot wire 3 is heated by a control circuit 8 to a constant overtemperature compared to the gas temperature. The throughflow direction of the channel 2 is indicated exemplary by an arrow 5. The hot wire 3 and the measuring sensor 4 comprise thin platinum wires which are attached to support wires (6, 7) within the channel 2. The control circuit 8 includes a control circuit (not shown in FIG. 1) with which the ohmic resistance of the hot wire 3 is maintained at a pregiven value.

The hot wire 3 cools down with gas flowing through the channel 2 so that the current flowing through the hot wire 3 is increased by the control circuit 8. The change of the heating current is an index for the flow velocity of the gas. The hot wire is controlled by the control circuit 8 to a constant overtemperature relative to the gas temperature. For this reason, the gas temperature must be additionally detected with the measuring sensor 4. The measuring sensor 4 is connected via a series resistor 9 and a switch 10 to a current source 11. The switch 10 comprises three contact arms (12, 13, 14) and is driven with control pulses Uₛ by a pulse voltage source 15 so that the contact arms (12, 13, 14) are closed for short time intervals tₑ and are thereafter reopened. In this way, current and voltage pulses occur at the measuring sensor 4 which are detected with the amplifiers (16, 17). The amplifier 16 measures the voltage drop across the series resistor 9 and thereby a quantity proportional to the current; whereas, the amplifier 17 evaluates the voltage drop at measuring sensor 4.

The output signals of the amplifiers (16, 17) reach a voltage detector 18 and a current detector 19 via contact arms (13, 14), respectively. The measuring voltage U_{M}, which drops across measuring sensor 4, and the measuring current I_{M} are determined with detectors (18, 19) when the contact arms (12, 13, 14) are closed. The detectors (18, 19) receive synchronous pulses from an evaluation unit 21 in order to detect the measuring voltage U_{M} and the measuring current I_{M} at the same time point. The time point is so selected that it lies at the end of the control pulse when the transient action is finished.

Switching circuit 20 is connected downstream of the detectors (18, 19). The switching circuit 20 is part of the evaluation unit 21 and the quotient of U_{M} and I_{M} is formed in the switching circuit 20. This quotient indicates the ohmic resistance of the measuring sensor 4 and therefore the temperature of the gas. The temperature measuring signal is transmitted further via a line 22 to the control circuit 8 so that the gas temperature, which is required for the control to the constant overtemperature, can be considered in the control circuit 8.

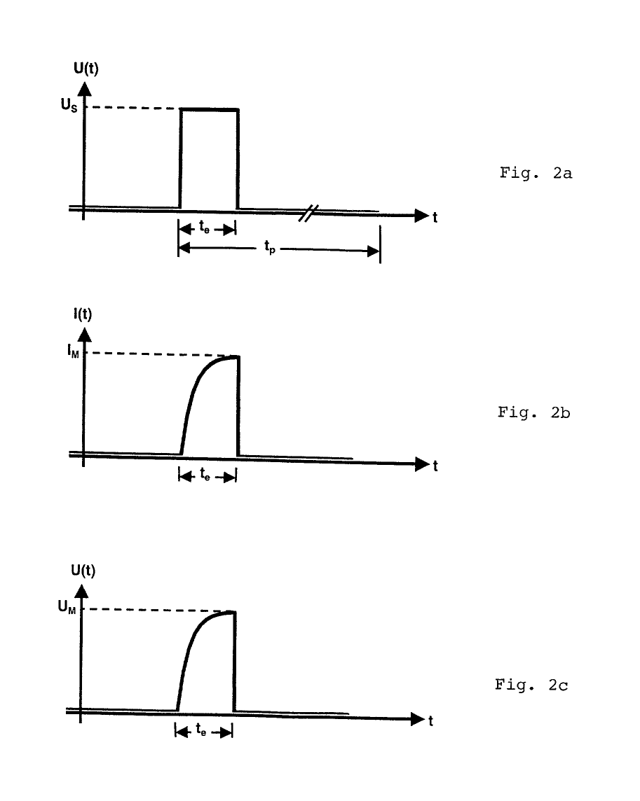

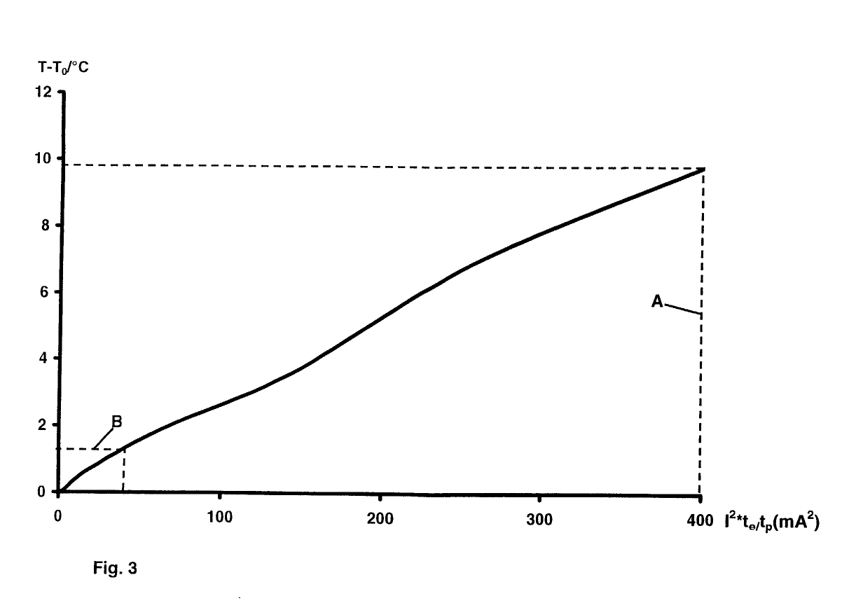

FIG. 2a shows, as exemplary, the time-dependent trace of the control pulses Uₛ(t) of the pulse voltage source 15. FIG. 2b shows the current trace I(t) at the measuring element 4 and FIG. 2c shows the voltage trace U(t) at the measuring element 4. The switch-on time tₑ amounts, for example, to 50 microseconds for a period duration tₚ of 5 milliseconds. Within the switch-on time tₑ, the voltage and current increase to the maximum values U_{M} and I_{M}, respectively. In the present case, the current amplitude is 20 milliamperes. The influence of the pulse operation on the inherent warming of the measuring sensor 4 is shown in FIG. 3. The inherent warming is plotted along the ordinate as a difference (T-Tₒ) referred to a reference temperature Tₒ; whereas, the square of the current I(t), which flows through the measuring sensor 4, is plotted along the abscissa. The ratio (tₑ/tₚ) of the switch-on time tₑ to the period duration tₚ is given. In FIG. 3, individual measuring points are connected to form a deviation line. In the ideal case, a linear relationship is present between the inherent warming of the measuring sensor 4 and the square of the measuring current I² (t), that is, the supplied power.

The effects of the current-pulse operation on the inherent warming will now be presented with respect to two numerical examples.

A measuring current I(t) of 20 milliamperes flows continuously through the measuring sensor 4 with tₑ/tₚ equal 1 leads to an inherent warming of approximately 9.8°C. (parameter A). By clocking the measuring current with a ratio tₑ/tₚ equal to 1:10, the inherent warming reduces for the same current amplitude to 1.5° C. (parameter B). From FIG. 3, suitable currents I(t) and clock ratios tₑ/tₚ can be taken at a given inherent warming (T-Tₒ).

It is understood that the foregoing description is that of the preferred embodiments of the invention and that various changes and modifications may be made thereto without departing from the spirit and scope of the invention as defined in the appended claims.

What is claimed is:

1. An arrangement for measuring the temperature of a fluid, the arrangement comprising:
a measuring sensor disposed in said fluid and having an ohmic resistance;
a current source for generating and supplying measuring current pulses to said measuring sensor;
a voltage detector connected to said measuring sensor for detecting a measurement voltage (U_{M}) across said measuring sensor;
a current detector for detecting the measurement current (I_{M}) corresponding to said measurement voltage (U_{M});
a switching circuit for forming a quotient from said measurement voltage (U_{M}) and said measurement current (I_{M}) with said quotient (U_{M}/I_{M}) indicating said ohmic resistance of said measuring sensor.

2. A method for measuring the temperature of a fluid, the method comprising the steps of:
providing a measuring sensor disposed in said fluid and said measuring sensor having an ohmic resistance;
applying measuring current pulses to said measuring sensor thereby causing a measurement voltage (U_{M}) to drop across said measuring sensor;
detecting said measurement voltage (U_{M}) and the measurement current (I_{M}) corresponding thereto; and,
forming a quotient (U_{M}/I_{M}) from said measurement voltage (U_{M}) and said measurement current (I_{M}) which indicates said ohmic resistance of said measuring sensor.

3. The method of claim 2, wherein the maximum values of said measurement voltage (UM) and said measurement current (IM) are taken to form said quotient.

4. The method of claim 3, comprising the further step of adjusting the amplitude of said measurement current to values lying in the range of 5 to 20 milliamperes.

5. The method of claim 3, comprising the further step of adjusting the ratio of the pulse duration tₑ to the period duration tₚ of said measurement current to values lying in a range of 1:10 to 1:100.
